(19) United States
(12) Patent Application Publication
(10) Pub. No.: US 2026/0045239 A1
(43) Pub. Date: Feb. 12, 2026

(54) Guitar Pick Assembly

(71) Applicant: Jeff Garrison, Los Molinos, CA (US)

(72) Inventor: Jeff Garrison, Los Molinos, CA (US)

(21) Appl. No.: 19/264,437

(22) Filed: Jul. 9, 2025

Related U.S. Application Data
(60) Provisional application No. 63/680,316, filed on Aug. 7, 2024.

(51) Int. Cl. G10D 3/173

(52) U.S. Cl. CPC G10D 3/173

(57) ABSTRACT

A guitar pick assembly for flat picking and thumb picking is disclosed. The guitar pick assembly includes a thumb ring designed for user comfort and stability, a flat guitar pick with openings for cord attachment, a cord to secure the flat guitar pick to the thumb ring for allowing positional adjustment, a choke collar to maintain the pick position a barrel stops for limiting the pick movement. The thumb ring includes a rubberized or friction-enhancing coating to reduce slippage on the user thumb, structural support to prevent rotation, and an electronic module includes an accelerometer, gyroscope, and wireless communication for tracking pick movement. The assembly allows the pick to be positioned for thumb picking or extended for flat picking, with adjustable cord lengths determining distance from the thumb ring. Additionally, the assembly includes LED indicators, a magnetic resonance system for string vibration, and a bungee cord for pitch modulation.

### CROSS-REFERENCE TO RELATED DOCUMENTS

This application claims priority to a Provisional application having a title; “Guitar Pick Assembly” having the application No. 63/680,316, filed Aug. 7, 2024, herein incorporated by reference.

### BACKGROUND OF THE INVENTION

### Field of the Invention

This disclosure relates generally relates to guitar pick accessories and more particularly relates to a guitar pick assembly for flat picking and thumb picking.

### Discussion of the State of the Art

In the art of guitar playing, guitar players may play guitar strings using fingers and thumb, or guitar picks adapted to be held by the guitar player as a single flat pick as they are termed in the art, or as a pick form extension of a thumb or finger ring. Guitar picking is an art that has a long history. Guitar picking is typically associated with acoustic guitar playing and is associated with genres of music generally classed as bluegrass music. In bluegrass and other forms, the player may use a thumb pick and finger picks to play the guitar strings, to produce the guitar picking sound popular in the genre.

Guitar picking may also occur in other genres of music and in association with an electric guitar. Generally speaking, flat picks, which are generally specified as a single flat pick held between the thumb and forefinger, are associated with both lead guitar and rhythm guitar performance. Guitar picks are typically thin and made of a hard resilient plastic material that is resistant to wear and breakage. As music has evolved, the lines between different styles of playing guitar have blurred as players create fusion styles that may mix slide guitar, flat guitar picking, and rhythm guitar strumming in a single song or in a guitar solo section of a single song.

Common drawbacks of picking with a flat pick are breaking the pick and dropping or losing the pick. Other challenges for guitar players include swapping picks and slides to play alternate styles in a same section of music. A player picking with a thumb pick may have to remove the thumb pick, place it down, grab a flat pick, and continue playing with the flat pick for a section before placing the flat pick down and re-donning the thumb pick for thumb picking a next section, or swapping it out for a slide bar for an adjacent slide section. All of these movements are challenging and mistakes are fairly common, including misplacing picks, dropping them and having to retrieve them.

Therefore, what is clearly needed is a flat pick assembly that may be operated by the player as a thumb pick or as a flat pick on demand.

### SUMMARY OF THE INVENTION

In an embodiment, a guitar pick assembly for flat picking and thumb picking is disclosed. The guitar pick assembly includes a thumb ring for wearing on the user's thumb, a flat guitar pick modified with openings for securing to the thumb ring using a cord includes a first end and a second end, a choke collar on the cord to maintain the pick position relative to the thumb ring, a barrel stops at the ends of the cord to limit the pick movement.

In an embodiment the thumb ring includes a rubberized coating, structural supports to prevent rotation and the choke collar includes various clamping mechanisms.

In an another embodiment, the assembly allows for two configurations of the pick includes secured for thumb picking or extended for flat picking, with cord length determining the extension distance.

In an additional embodiment of the present disclosure the guitar pick assembly includes an electronic module inside the thumb ring containing an accelerometer, gyroscope, and wireless communication interface for transmitting pick movement data, an optional magnetic resonance system to induce string vibration, an optional bungee cord attachment to a guitar tremolo bridge for pitch variation during strumming. Additionally, the assembly include an LED lighting system for motion indication or low-light illumination, and the ability to modulate sound effect parameters based on real-time pick movement data.

It is to be understood that both the foregoing general description and the following detailed descriptions are exemplary and explanatory only and are not restrictive of the invention, as claimed.

### BRIEF DESCRIPTION OF THE DRAWING FIGURES

The accompanying drawings, which are incorporated in and constitute a part of this disclosure, illustrate exemplary embodiments and, together with the description, serve to explain the disclosed principles.

FIG. 1 illustrates a front view of a guitar pick assembly, in accordance with an embodiment of the present disclosure;

FIG. 2 illustrates a side elevation view of the guitar pick assembly as shown in FIG. 1, in accordance with an embodiment of the present disclosure;

FIG. 3 illustrates an underside view of the guitar pick assembly as shown in FIG. 1, in accordance with an embodiment of the present disclosure;

FIG. 4 illustrates a rotated underside view of the guitar pick assembly as shown in FIG. 3, in accordance with an embodiment of the present disclosure;

FIG. 5A illustrates a perspective view of a guitar pick assembly, in accordance with an embodiment of the present disclosure;

FIG. 5B illustrates a perspective view of the opposite side of guitar pick assembly as depicted in FIG. 5A, in accordance with an embodiment of the present disclosure;

FIG. 6 illustrates an additional embodiment of the present disclosure; and FIGS. 7 and 8 illustrate the embodiment depicted in FIG. 6.

### DETAILED DESCRIPTION

The foregoing description has broadly outlined the features and technical advantages of the present disclosure in order that the detailed description of the disclosure that follows may be better understood. Additional features and advantages of the disclosure will be described hereinafter which forms the subject of the claims of the disclosure. It should be appreciated by those skilled in the art that the conception and specific embodiments disclosed may be readily utilized as a basis for modifying other devices, systems, assemblies, and mechanisms for conducting the same purposes of the present disclosure. It should also be realized by those skilled in the art that such equivalent constructions do not depart from the scope of the disclosure as set forth in the appended claims. The novel features which are believed to be characteristics of the disclosure, to its device or system, together with further objects and advantages will be better understood from the following description when considered in connection with the accompanying figures. It is to be expressly understood, however, that each of the figures is provided for the purpose of illustration and description only and is not intended as a definition of the limits of the present disclosure.

The terms “including”, “comprises”, “comprising”, “comprising of” or any other variations thereof, are intended to cover a non-exclusive inclusion, such that a system or a device that comprises a list of components or steps does not include only those components or steps but may include other components or steps not expressly listed or inherent to such setup or device. In other words, one or more elements in a system or apparatus proceeded by “comprises . . . a” does not, without more constraints, preclude the existence of other elements or additional elements in the system or apparatus.

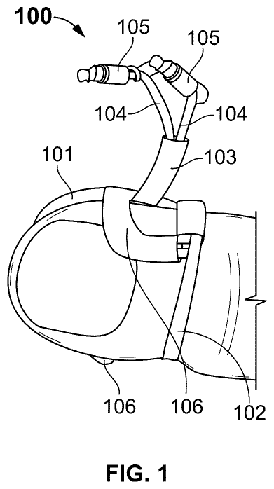

Reference will now be made to the exemplary embodiments of the disclosure, as illustrated in the accompanying drawings. Wherever possible, same numerals have been used to refer to the same or like parts. The following paragraphs describe the present disclosure with reference to FIG. 1-FIG. 8.

FIG. 1 illustrates a front view of a guitar pick assembly 100 worn by a user, in accordance with an embodiment of the present disclosure. The guitar pick assembly 100 is configured to be used by a guitar player for both thumb picking and flat picking during a guitar performance, without necessitating the interchange of picks. The guitar pick assembly 100 comprises an integration of a flat guitar pick 101 with a thumb ring 102. The thumb ring 102 may adopt various structural configurations without departing from the spirit and scope of the present disclosure. The flat guitar pick 101 is a conventional guitar pick adapted for use either as a flat pick or as a thumb pick in conjunction with the thumb ring 102.

In the present embodiment, the flat guitar pick 101 is modified to accommodate a cord 104 that is threaded through an opening in the pick body from one side and then back through a second opening to exit on the original side. The cord 104 may be an elastic cord, such as a bungee-type cord, or alternatively, may be a non-elastic wire or nylon cord, without deviating from the scope of the present invention. The open ends of the cord 104 are threaded through a choke collar 103. The ends of the cord 104 are further passed through a pair of barrel stops 105, secured in place by tying off the ends at equal lengths. The barrel stops 105 may be elongated or round, fabricated from metal, plastic, or other materials without departing from the scope of the present disclosure. While in this embodiment, the barrel stops 105 are barrel-shaped, this particular geometry is not a critical limitation.

The thumb ring 102 may be a thin-band ring incorporating structural support elements 106 designed to stabilize the ring and prevent rotational displacement on the user's thumb. The thumb ring 102 may further include a rubberized or friction-enhancing coating to reduce slippage. Additionally, a thumb ring base structure (not illustrated) is provided on one side of the guitar pick assembly 100 to function as a stop plate structure. This base structure positions the flat pick 101 against the thumb ring 102 in a parallel orientation at a predetermined spatial offset from the ring band, wherein the spacing distance is equivalent to that of a conventional one-piece thumb pick.

The ends of the cord 104 may be inserted through the choke collar 103, wherein the collar 103 exerts a frictional force sufficient to maintain the guitar pick 101 in an operable orientation relative to the thumb ring 102 for thumb picking. A user may manipulate the barrel stops 105 to secure the flat pick 101 into a thumb pick position, with the position maintained by the friction of the choke collar 103. In this configuration, the guitar pick assembly 100 functions as a thumb pick. When required for flat picking, the guitar pick 101 may be displaced from the side of the thumb ring 102 by a distance determined by approximately half the length of the cord 104. The cord 104 traverses through the choke collar 103, with the barrel stops 105 acting as a limiting structure to prevent complete detachment of the pick 101 from the thumb ring 102. In this loosened state, the player may employ the flat pick 101 in a conventional manner while maintaining the ring 102 on the thumb.

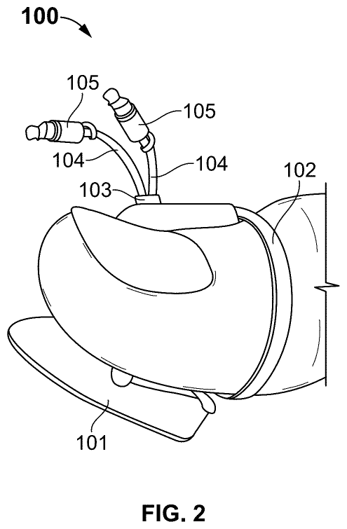

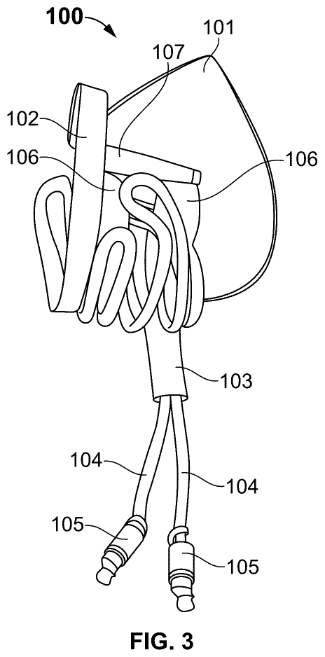

FIG. 2 illustrates a side elevation view of the guitar pick assembly 100 as shown in FIG. 1, in accordance with an embodiment of the present disclosure. This view represent the distance between the flat pick 101 and the thumb ring 102 when cinched in place. The choke collar 103 is positioned laterally relative to the thumb ring 102, opposite the pointed end of the flat pick 101. In this embodiment, the barrel stops 105 are pulled outward through the choke collar 103 to maintain the flat pick 101 in a thumb-pick configuration relative to the thumb ring 102. If a user extends the pick 101 outward for flat picking, the barrel stops 105 about the opening of the choke collar 103, thereby preventing further displacement.

In one embodiment, the barrel stops 105 may be attached to the cord ends 104 after being threaded through the choke collar 103 and one or more openings in the thumb ring 102. The choke collar 103 may be configured with a clamping mechanism, such as a lever clamp or side clamp mechanism, allowing for selective engagement and disengagement of the cord 104 while remaining within the scope of the invention.

In another embodiment, the choke collar 103 may be a tubular structure through which the cord ends 104 slide freely. In this configuration, a separate clamping mechanism may be provided on the thumb ring 102 ahead of the choke collar 103 to selectively secure the cord ends when the guitar pick 101 is positioned for thumb picking. Upon disengagement of the clamp, the guitar pick 101 may be extended away from the thumb ring 102 for use as a flat pick. The maximum extension distance of the guitar pick 101 from the thumb ring 102 is determined by the length and dimension of the cord 104.

FIG. 3 illustrates an underside view of the guitar pick assembly as shown in FIG. 1, in accordance with an embodiment of the present disclosure, incorporating a modified thumb ring 102 configuration. In this embodiment, the thumb ring 102 features a structurally distinct design without altering the function of the assembly. Consequently, the element numbering for the guitar pick assembly 100 and the thumb ring 102 remains unchanged.

In this embodiment, the thumb ring 102 is a thin-band ring incorporating a side structure affixed to the band via welding, soldering, or another attachment method. The guitar pick 101 is offset toward one side of the thin-band ring 102 to maintain proper thumb pick orientation. The guitar pick 101 is secured against support structures 106 via a bridge component 107. In a preferred embodiment, the support structures 106 are integral to the thumb ring 102 and remain affixed to the ring. The bridge component 107 may be a hollow or perforated structure permanently attached to the guitar pick 101 using adhesive or may be threaded onto the cord 104 ahead of the choke collar 103. The cord 104 is threaded through the choke collar 103 and the bridge structure 107, looping through the guitar pick 101 such that pulling the barrel stops 105 rearward secures the guitar pick 101 against the structures 106 at the bridge component 107, maintaining the pick 101 at the appropriate orientation and offset for thumb picking.

In this embodiment, the distance that pick 101 may be removed from ring body 102 is equal to the lengths of the cord ends of cord 104 from the proximal opening of choke collar 103, to the cording knots ahead of barrel stops 105. In this embodiment, a thumb of the player enters ring body 102 from the left side, with the thumbnail of the player facing the viewer of this view. The overall length of cord 104 dictates how far guitar pick 101 may be pulled away from ring body 102, to be used as a flat guitar pick. In a preferred embodiment, guitar pick 101 with barrel stops extended, allows the pick to be held between the thumb and forefinger of the player, while the player is still wearing ring body 102.

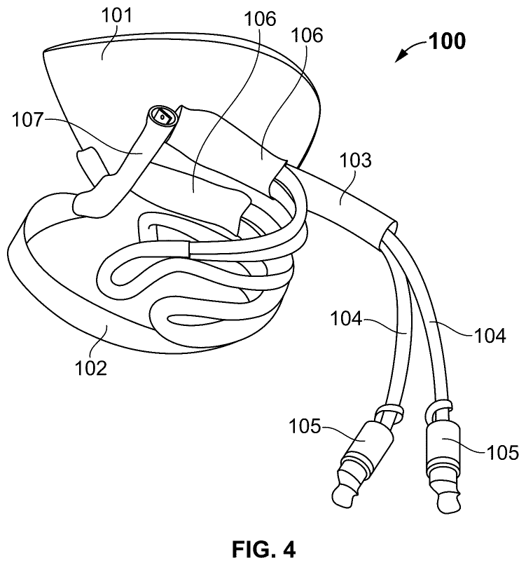

FIG. 4 illustrates a rotated underside view of the guitar pick assembly 100 as shown in FIG. 3, in accordance with an embodiment of the present disclosure. This perspective depicts the assembly in a taut configuration, demonstrating the offset between the centerlines of the guitar pick 101 and the thumb ring 102. In one embodiment, the bridge structure 107 is permanently affixed to the structures 106, which are contiguous with the thumb ring 102 and feature a rubberized or friction-enhancing coating encompassing the choke collar 103 and bridge structure 107. In this embodiment, the guitar pick 101 remains unmodified except for the provision of openings for threading the cord 104.

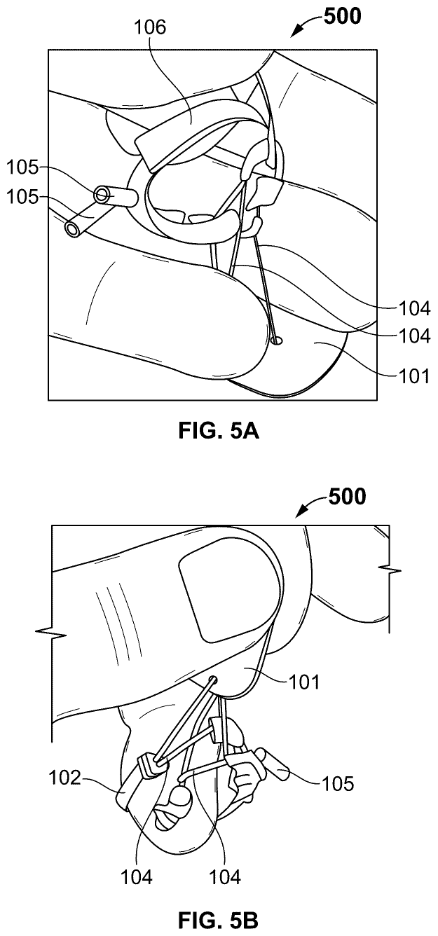

FIG. 5A illustrates a perspective view of a guitar pick assembly 500, in accordance with an embodiment of the present disclosure. Wherein a flat pick is depicted as being pulled away from a ring body, in accordance with an embodiment of the present disclosure. FIG. 5B illustrates a perspective view of the opposite side of guitar pick assembly 500 as depicted in FIG. 5A, in accordance with an embodiment of the present disclosure.

In reference to FIG. 5A, guitar pick assembly 500 is configured to secure a guitar pick 101 to a ring body 102 via an elastic cord 104. In the illustrated embodiment, ring body 102 comprises two bands that are not fully enclosed into continuous circular forms, thereby defining a gap, such that the ring body forms a double-band structure. The bands further comprise anchor points for securing or tying the elastic cord 104 at a first side of the gap. On a second side of the gap, the ring body defines two openings, one at each termination point of the bands, wherein the openings are configured to receive the elastic cord 104 there through. In the present embodiment, a wrapped structure 106 is disposed on an opposite side of the gap. Notably, in this embodiment, no choke collar is provided to introduce friction to the elastic cord; rather, the elastic cord 104 comprises a bungee-type cord configured to maintain tension.

With reference now to FIG. 5B, the opposite side of guitar pick assembly 500 illustrates the routing of elastic cord 104 through corresponding openings defined through guitar pick 101, wherein elastic cord 104 extends toward four respective termination points of ring body 102, including across the gap. The free ends of elastic cord 104 are secured at two anchor points on a first side of the gap and routed through collar-type structures affixed to the ring bands on the second side of the gap, terminating in barrel stops 105. The barrel stops 105 correspond to those depicted in FIGS. 1-4.

In operation, a user may selectively pull outward on guitar pick 101, which is elastically secured to ring body 102, thereby enabling the guitar pick to function as a flat pick while the user continues to wear the ring body. Upon release, the guitar pick 101 is biased by the elastic cord 104 to return to a secured, offset position adjacent to the ring body at the gap structure, wherein the elastic tension within the elastic cord 104 is sufficient to maintain the guitar pick 101 in a stable position against the ring body 102. In this embodiment, the engagement of the barrel stops 105 against the external surface of ring body 102 eliminates the necessity of manually pulling the barrel stops to re-secure the pick. The elastic tension provides sufficient resistance to allow the guitar pick 101 to function as a thumb pick when secured against the ring body 102. As such, the guitar pick assembly is operable as both a flat pick and a thumb pick.

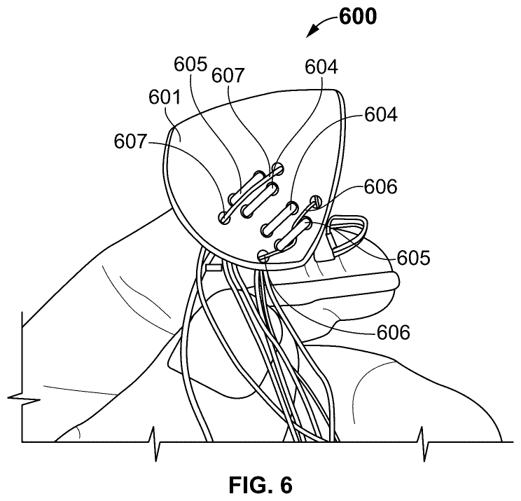

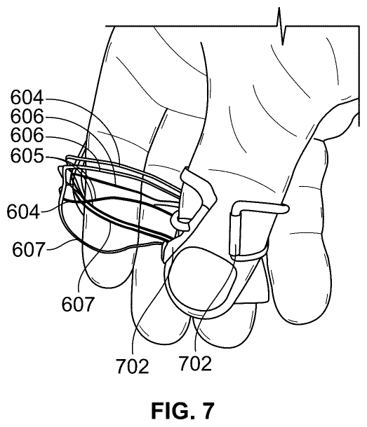

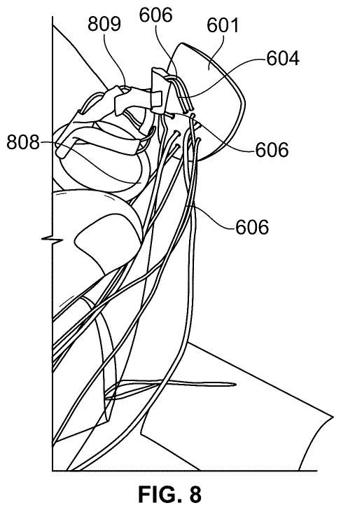

With reference now to FIG. 6, an additional embodiment of the present disclosure is depicted, wherein the guitar pick assembly 600 integrates features and functionalities of both a thumb pick and a flat pick while further incorporating electronic sound capabilities for use with an electric guitar. In this embodiment, the guitar pick assembly 600 enables precise control over tonal characteristics during play by dynamically adjusting the tension, positioning, and angles of the pick assembly. The embodiment allows the user to preprogram and customize the tonal qualities, volume levels, and the extent or nature of sound effects by adjusting the positioning of the cords within the pick assembly 600.

As illustrated in FIG. 6, the upper surface of pick 601 defines a plurality of circular openings configured to receive and secure portions of the cord system. The cords extend through the underside of pick 601 and connect to a thumb ring 702. In this embodiment, an adjustment cord 604 is woven through two sets of two openings, thereby securing the woven portion in specific positions to facilitate tightening of the thumb ring and optimizing pick positioning during use. Additionally, four opposing openings (total of eight) are configured to retain respective positioning cords 607, one on each side. The positioning cords 607 are woven through the openings in a parallel configuration. Furthermore, the positioning cords 607 are intersected at two inner openings on each side by a retaining cord 605, which serves to anchor and maintain friction against the positioning cords 606, 607, thereby securing them in place during adjustment. The positioning cords may be selectively adjusted to modify the extension and angular orientation of the pick relative to the thumb, thereby enabling operation as either a flat pick or a thumb pick.

FIGS. 7 and 8 illustrate the embodiment depicted in FIG. 6, wherein the thumb ring 702 is positioned on the user's thumb, with cords 604-607 extending between the thumb and guitar pick 601. As shown in FIG. 8, the assembly comprises two positioning cords 606, 607, one adjustment cord 604, and a retaining cord 605, wherein the adjustment cord 604 is secured at two parallel positions on pick 601. The cord configuration enables dynamic modifications to the pick's positioning, thereby affording the user the ability to switch between flat pick and thumb pick functionalities while maintaining stability and control.

The Thumb ring 702 is perfectly designed to fit the thumb comfortably, while securing to the thumb ring 702 assembly and pick to the thumb. This ideal design also allows the bracket to automatically adjust to fit any size thumb, while the design also allows the pick edge of the thumb to be used for the technique known as “pinch harmonics.

The thumb ring 702 holds the cords in place, so that the cords are able to hold the pick in place, while still allowing the flat pick to function as a firm thumb pick or as a flat pick normally would. The cords attached to the thumb ring 702 are routed to and through the pick, and back to and through to and through the backside of the thumb ring 702 for being able to adjust the pick's position, firmness or flexibility, and range of motion in every direction by loosening or tightening the adjustment bands, leaving the pick floating perfectly in place underneath the thumb without having to use the other fingers to hold onto “The Perfect Guitar Flat/ThumbPick.” And although guitar is in the name, it can be used for any stringed instrument.

The heart of the invention is in each and every aspect of the entire design. The thumb ring 702 allows the user to use it as a flat pick or a thumb pick or both and play unencumbered. The cords combined with the design of the thumb ring allows for the user to adjust the position, range of motion and tension of guitar pick 601. Thus, allowing the user to adjust the pick's exact position on the thumb, as well as the amount of tension, resistance, range of motion and travel distance of the pick. By adjusting the dedicated cords 606 for the tip of the pick to travel in distance downwards =the resistance/tension against the up strum, and dedicated cords 607 for the travel distance of the back of the pick as the resistance to the down strum, while also controlling an amount of resistance to the actual wiggle of the pick up and down with cords 604.

The design of the holes through the pick is patterned to utilize the multiple cords to most effectively allow the user to adjust every aspect of how a flat/thumb pick functions as both a flat pick and/or a thumb pick, empowering the user to fine-tune to their exact preferred specifications. Altogether, the thumb ring 702, cords and pick allow the user to use a flat pick without having to hold onto the pick, making learning to use a pick and strum or fingerpick easier than ever. The user never has to worry about dropping the pick, or if they're holding it too lightly or too firm. They never have to worry if it's at the right angle to the strings or if it's not sticking out from their thumb far enough, causing them to miss the strings or if it is sticking out from their thumb too far and getting caught in the strings.

Guitarists that use flat picking and fingerpicking in the same song and having to drop the pick, set it down quickly and then grab another pick after the fingerpicking part is over or awkwardly hold the pick with the pinky of the fingerpicking hand while fingerpicking and then have to take the time to get the pick back in between their finger(s) and thumb properly, all so they can switch back and forth between using a pick and not using a pick, is over. The current disclosure allows the user to use all of their fingers to fingerpick and strum and seamlessly switch back and forth between flat picking and fingerpicking, instantly, without any pause to grab another pick, or the user have to hope that they don't end up fumbling with the pick or let it take any time away from playing, whether with a flat pick or fingerpicking or flat picking, it's all there and ready to be used instantly. The back side of the thumb ring 702 assembly houses all of the electronics.

The Bluetooth signal emitted from the perfect pick is connected and controlled through the user's cell phone, tablet, laptop or desktop. This allows the user to track their rhythm, strumming distance and timing, in real-time, giving them the ability to see, correct and practice the most accurate and precise technique. Thus, they can continue to, adjust, refine and perfect their rhythm, timing and overall strumming and picking technique. The user is also able to program the up and down movement of The Perfect Flat/Thumb Pick to control the parameters of the desired guitar sound effects, by utilizing the same gyroscopes that cell phones us to detect movement of the cell phone to indicate whether to switch from portrait mode to landscape and vice-versa. By having gyroscopes measure the movement, it will trigger the signal to show each exact movement of the user's right hand, which is what signals the computer to make the designated changes to the sound, according the user's pre-programmed parameters of the sound effects. Allowing the user to customize the sound by the amount of the user's choosing. This is/can also be indicated by the LED lights (not shown) that light up different colors as a novelty function, or it can be used to light up the strings for the user to be able to see the strings in the dark.

The Magnetic Resonance system allows the user to sustain any string indefinitely. The electromagnets causes an interference pattern that vibrates the desired string, causing the string to ring-out for as long as the button is pressed or if left on, as long as the user holds the back of the thumb ring 702 near the string to sustain. This creates a unique cello or violin-like legato sound that opens up a whole new dimension of possibilities.

A separate attachment that connects the thumb ring 702 to the wrist to the bridge of the guitar by a larger bungee cord that attaches from the wrist strap to where the whammy bar normally connects to the tremolo bridge system. This wrist strap bungee cord stretches with every strum essentially tightening and loosening the tension of the strings by providing a light amount of pressure on the tremolo bridge.

So the tremolo bridge connecting to the stretching bungee, makes the pitch of the guitar vary ever so slightly with every strum, making a sound reminiscent of being underwater or in a dream-like state. So, if one can imagine hearing music underwater or in a dream-like state, then you can imagine what it would sound like.

In this embodiment, the electronics (not shown) include at least an accelerometer to determine position and movement. The electronics also enable the user program electronic drums sounds triggered/signaled to be executed based upon the exact movements of their plucking and strumming, and it can also be used as a practice tool to monitor, correct and refine the user's picking, plucking, and strumming techniques by allowing them to use an accompanying application (not shown) on their phone or computer to provide a visual representation of their exact movements, to measure and examine their techniques and revealing any and all wasted or inaccurate movements or motions, and showing them how they might have an uneven tempo =speeding up or slowing down in the middle of their performances, rehearsals, or practices, thus empowering the user to correct their mistakes and master their techniques, rhythm, timing, and tempos during live use.

### Features

1. Thumb ring 702—comfortably secures pick to thumb
2. Cords—hold pick to Thumb ring 702 and to thumb, while allowing user to adjust every aspect of how the pick functions.
3. Specially designed Flat/Thumb Pick w/ideal hole pattern—allows the user to fine-tune the position, range of motion, travel distance, and tension of the pick by adjusting the . . .
4. Adjustment Bands—used to make The Perfect Flat/Thumb Pick function to user's exact specifications.
5. Electronics—sends signal to computer=cell phone, tablet, laptop, desktop, via Bluetooth or wireless signal. Allowing the user to use the . . .
5a. Picking & Strumming Map & Chart—Signal allows the user to use the Chart to fine-tune their strumming and picking techniques in real-time. As well as . . .
5b. The Motion based manipulation of Sound Effects—Signal can also be used to program and adjust the parameters of sound effects to change the settings based upon the motion of The Perfect Flat/Thumb Pick, it's movements and how it's used.
6. LED Light—can be used to light up as different colors for up strum, down strum, flat pick up & down strokes, fingerpicking . . . or to light up the strings for playing in the dark.
7. Magnetic Resonance—small pulsing electromagnets are signaled to cause the string to vibrate, making the string sound sustain as long as in is held in place.
8. The Thumb ring 702 to Wrist Strap Bungee attachment to the tremolo bridge system on a guitar, allows the user to produce a unique wavering sound with every strum and pluck of a string.

The cords attached to the thumb ring 702 are routed to and through the pick, and back to and through to and through the top side of the thumb ring 702 for being able to adjust the pick's position, firmness or flexibility, and range of motion in every direction by loosening or tightening the adjustment cords 607, 606, 604 and 605, leaving the pick floating perfectly in place underneath the thumb without having to use the other fingers to hold onto “The Perfect Guitar Flat/ThumbPick.” And although guitar is in the name, it can be used for any stringed instrument.

By adjusting the dedicated cord 604 for the tip of the pick to travel in distance downwards=the resistance/tension against the up strum, and dedicated cords 604 for the travel distance of the back of the pick as the resistance to the down strum, while also controlling the amount of resistance to the actual wiggle of the pick up and down with cords 606 and 607.

Adjusting the length the pick is as simple as pulling cords 604 while sliding the pick forwards or backwards, thus adjusting the length the pick towards or away from the strings to the users preference. The design of the holes through the pick is patterned to utilize the multiple cords to most effectively allow the user to adjust every aspect of how a flat/thumb pick functions as both a flat pick and/or a thumb pick, empowering the user to fine-tune to their exact preferred specifications. Altogether, the thumb ring 702, cords and pick allow the user to use a flat pick without having to hold onto the pick, making learning to use a pick and strum or fingerpick easier than ever. The user never has to worry about dropping the pick, or if they're holding it too lightly or too firm. They never have to worry if it's at the right angle to the strings or if it's not sticking out from their thumb far enough, causing them to miss the strings or if it is sticking out from their thumb too far and getting caught in the strings. And, the present disclosure allows the user to use all of their fingers to fingerpick and strum and seamlessly switch back and forth between flat picking and fingerpicking, instantly, without any pause to grab another pick, or the user have to hope that they don't end up fumbling with the pick or let it take any time away from playing, whether with a flat pick or fingerpicking or flat picking, it's all there and ready to be used instantly. The back side of the thumb ring 702 assembly houses all of the electronics. The Bluetooth signal emitted from the perfect pick is connected and controlled through the user's cell phone, tablet, laptop or desktop. This allows the user to track their rhythm, strumming distance and timing, in real-time, giving them the ability to see, correct and practice the most accurate and precise technique. Thus, they can continue to, adjust, refine and perfect their rhythm, timing and overall strumming and picking technique. The user is also able to program the up and down movement of The Perfect Flat/Thumb Pick to control the parameters of the desired guitar sound effects, by utilizing the same gyroscopes that cell phones us to detect movement of the cell phone to indicate whether to switch from portrait mode to landscape and vice-versa. By having gyroscopes measure the movement, it will trigger the signal to show each exact movement of the user's right hand, which is what signals the computer to make the designated changes to the sound, according the user's pre-programmed parameters of the sound effects. Allowing the user to customize the sound by the amount of the user's choosing.

It will be apparent to one with skill in the art that the guitar pick assembly of the present invention may be provided using some or all of the elements described herein. The arrangement of elements and functionality thereof relative to the guitar pick assembly of the present invention is described in different embodiments, each of which is an implementation of the present invention. While the uses and methods are described in enabling detail herein, it is to be noted that many alterations could be made in the details of the construction and the arrangement of the elements without departing from the spirit and scope of this invention.

The foregoing description and accompanying figures illustrate the principles, embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

The terms “comprises”, “comprising”, “includes”, “including”, “having” and their conjugates mean “including but not limited to” and indicate that the components listed are included, but not generally to the exclusion of other components. Such terms encompass the terms “consisting of”and “consisting essentially of”.

As used herein, the singular form “a”, “an” and “the” may include plural references unless the context clearly dictates otherwise. For example, the term “a compound” or “at least one compound”may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments or to exclude the incorporation of features from other embodiments.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the disclosure.

What is claimed is:

1. A guitar pick assembly comprising:
a thumb ring configured to be worn on a thumb of the user;
a flat guitar pick;
a cord includes a first end and a second end, wherein the flat guitar pick is modified to include at least two openings for threading the cord, securing the flat guitar pick to the thumb ring;
a choke collar disposed along the cord, wherein the choke collar is configured to exert a frictional force on the cord to maintain the flat guitar pick in a selected position relative to the thumb ring; and
at least two barrel stops secured to the first and second ends of the cord, wherein the barrel stops are configured to limit movement of the flat guitar pick relative to the thumb ring.

2. The guitar pick assembly of claim 1, wherein the thumb ring includes a rubberized or friction-enhancing coating to reduce slippage on the user thumb.

3. The guitar pick assembly of claim 1, wherein the thumb ring further includes structural support elements configured to stabilize the thumb ring and prevent rotational displacement.

4. The guitar pick assembly of claim 1, wherein the choke collar comprises a clamping mechanism selected from the group consisting of a lever clamp and a side clamp mechanism.

5. The guitar pick assembly of claim 1, wherein the choke collar is a solid tube that allows sliding movement of the cord, further comprising a separate clamping mechanism disposed on the thumb ring to secure the cord.

6. The guitar pick assembly of claim 1, wherein the barrel stops are elongated or round and composed of a material selected from the group consisting of metal, plastic, or another suitable material.

7. The guitar pick assembly of claim 1, wherein the thumb ring further includes a bridge component configured to secure the flat guitar pick against structural support elements of the thumb ring.

8. The guitar pick assembly of claim 7, wherein the bridge component is permanently affixed to the flat guitar pick using adhesive or threaded onto the cord ahead of the choke collar.

9. The guitar pick assembly of claim 1, wherein the flat guitar pick is positional in a first configuration in which it is secured against the thumb ring for thumb picking and a second configuration in which it is extended away from the thumb ring for flat picking.

10. The guitar pick assembly of claim 1, wherein the length of the cord determines the maximum distance the flat guitar pick is extended from the thumb ring for flat picking.

11. A guitar pick assembly comprising:
a thumb ring configured to be worn on a thumb of the user;
a guitar pick includes a plurality of openings;
a plurality of adjustable cords routed through the opening and secured to the thumb ring, wherein the cords enable fine-tuned positioning, tension modulation, and angular adjustment of the pick;
an electronic module housed within the thumb ring, wherein the module comprising an accelerometer, gyroscope, and wireless communication interface;
a signal transmission system configured to communicate pick movement data to an external device;
an optional magnetic resonance system configured to generate an interference pattern inducing continuous string vibration;
an optional bungee cord attachment extending from the thumb ring to a tremolo bridge of a guitar, wherein the attachment modulates pitch variations in response to strumming motion.

12. The guitar pick assembly of claim 11, wherein the electronic module further comprises an LED lighting system configured to visually indicate pick motion or provide illumination for low-light conditions.

13. The guitar pick assembly of claim 1, wherein the electronic module is configured to modulate sound effect parameters based on real-time pick movement data.
